(19) United States
(12) Patent Application Publication
(10) Pub. No.: US 2006/0251747 A1
(43) Pub. Date: Nov. 9, 2006

(54) Method of making and using mustard as an insect or rodent repellent or preservative

(76) Inventor: William L. Ritchie, Grand Forks, ND (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/281,244

(22) Filed: Nov. 17, 2005

Related U.S. Application Data
(60) Provisional application No. 60/628,622, filed on Nov. 17, 2004.

(51) Int. Cl. A01N 65/00

(52) U.S. Cl. 424/755

(57) ABSTRACT

The present invention relates to a composition of mustard and a method and system of using the mustard as an insect or rodent repellent or a preservative.

### CROSS REFERENCE TO RELATED APPLICATIONS

This application claims the benefit of U.S. Provisional Application No. 60/628,622, filed on Nov. 17, 2004, the contents of which is incorporated herein in its entirety be reference.

### FIELD OF THE INVENTION

The present invention relates to a method of making and using mustard, including treated mustard. More specifically, the present invention relates to the use of mustard, including treated mustard, as an insect or rodent repellent or a preservative.

### BACKGROUND OF THE INVENTION

Insects and rodents are typically a serious problem in milling plants, cereal grain processing facilities, and grain-based food processing plants.

Existing methods of controlling insect activity generally include chemical fogging, fumigation techniques, heat sterilization, sanitation, and infestation destroyers. The infestation destroyers use a process that includes an impeller to impact the flour into a metal ring, thereby destroying any larva or insects. Methods of controlling rodent activity generally include poisons or traps.

Thus, most existing insect control methods involve the application of chemicals that are not intended for consumption by humans or animals. Given that the end products of many of these plants and facilities are food products, the use of such chemicals is undesirable. Chemical use is an even greater problem for organic processing facilities, because there is significant pressure for the organic facilities to stop using chemicals altogether for insect control.

There is a need in the art for a method and system of insect and/or rodent control that includes components that are safe for consumption by humans or animals.

### BRIEF SUMMARY OF THE INVENTION

The present invention, in one embodiment, is a method of reducing the presence of insects or rodents in a target area. The method includes applying mustard or deheated mustard to the target area and can also include removing a portion of the mustard or deheated mustard.

The present invention, in another embodiment, is a method of coating a grain product. The method includes spraying a mixture onto a grain product to create a coating on the grain product, the mixture comprising deheated mustard powder and water, wherein the coating comprises insect repellent and preservative characteristics.

In a further embodiment, the present invention is a grain product coating comprising deheated mustard powder.

In another embodiment, the present invention is a method of deheating mustard. The method includes applying heat to mustard such that the mustard attains a temperature of at least 145° Fahrenheit, applying moisture to the mustard such that the mustard attains a moisture level of at least 5% moisture, and maintaining the temperature and moisture level for a period of at least 5 minutes.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### DETAILED DESCRIPTION

The present invention relates to a method and system for using mustard or treated mustard as an insect or rodent repellent or preservative. More specifically, the present invention relates to the action of mustard, or processed mustard, in controlling insects and/or rodents. That is, the presence of mustard or processed mustard decreases insect or rodent activity. The present invention further relates to the action of processed mustard as a preservative.

In one embodiment, the present invention relates to a method of treating mustard seed. The method of treating mustard seed, in accordance with one aspect of the present invention, includes the application of moisture and heat to the mustard seed. The application of moisture and heat acts to deactivate the myrosinase enzyme present in mustard seed, resulting in what is commonly known as “deheated mustard.” Traditional mustard flavor results from the action, in the presence of water, of the myrosinase enzyme system. That is, the myrosinase enzyme system releases an isothiocyanate that creates the sharp flavor characteristic to mustard. The method of processing mustard of the present invention (known in some embodiments as the “deheating process”) inactivates the myrosinase enzyme, thereby resulting in a bland flavored, “deheated” product.

In accordance with one embodiment, the method of treating (or “deheating”) mustard seed relates to the application of heated steam to mustard seed. In one embodiment, heat is applied to the mustard seed such that the temperature of the seed reaches a minimum temperature that ranges from at least about 145° Fahrenheit to at least about 2200 Fahrenheit. Alternatively, heat is applied such that the temperature of the seed reaches a minimum temperature that ranges from at least about 180° Fahrenheit to at least about 205° Fahrenheit. In a further alternative, heat is applied such that the temperature of the seed reaches a minimum temperature of at least about 180° Fahrenheit.

Moisture, in accordance with one aspect of the present invention, is applied to the mustard seed such that the moisture level of the overall seed composition reaches a minimum moisture level that ranges from at least about 5% moisture to at least about 15% moisture. Alternatively, moisture is applied such that the moisture level of the seed reaches a minimum moisture level that ranges from at least about 6% to at least about 9%. In a further alternative, moisture is applied such that the moisture level of the seed reaches a minimum moisture level of at least about 13% moisture.

In one embodiment of the present invention, the minimum levels of heat and moisture are maintained for a minimum period of time that ranges from about 5 minutes to about 15 minutes. Alternatively, the minimum levels of heat and moisture are maintained for a minimum period of 10 minutes. In one embodiment, the temperature maintained for the period of 10 minutes is 200° F.

According to one embodiment, the steam can be applied to the mustard seed in a mixing apparatus. The amount of time required for the application of steam to the mustard seed depends on the volume of mustard flowing into the steam mixer and the volume of steam that is being applied. The relationship is as follow: the greater the flow of mustard into the steam mixer, the more time required for the application of steam.

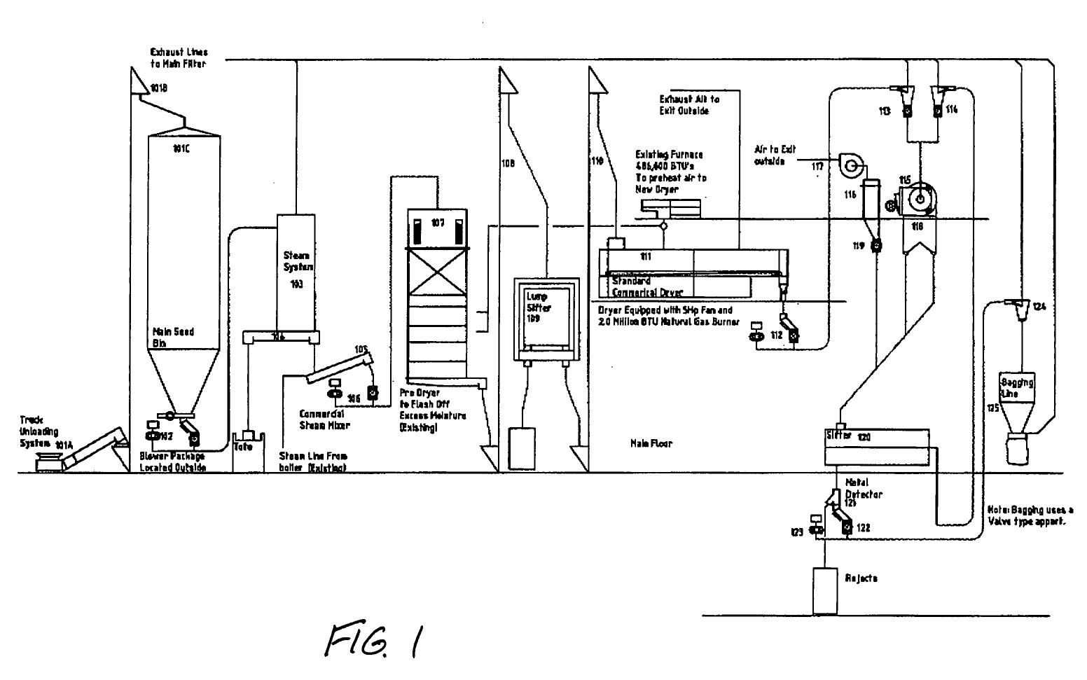

In one embodiment, the steam is applied to the mustard seed in a known commercial mixing apparatus that is inclined at a 20 degree angle. FIG. 1 depicts one commercial mixing apparatus system. The apparatus is known generally as a tempering screw. One type of tempering screw can be purchased from Codema, Inc. in Maple Grove, Minn. or Buhler Inc. in Plymouth, Minn. The device operates as follows: as seed enters the bottom of the mixer, the seed is worked through a series of paddles. The mixture, according to one embodiment, is configured such that by the time the seed is pushed out of the mixer, it has been steamed to the correct temperature and moisture.

According to one embodiment, the seed is being monitored as it exits the mixer by a handheld temperature unit. In one aspect of the invention, the monitoring of the seed temperature allows for quick adjustments to the mixer.

In one aspect of the present invention, the mustard seed is then transferred to a first drying system. The first drying system causes the removal of excessive moisture. The excessive moisture results from steam being applied to the seeds to the point that the seeds cannot physically retain any more moisture. The excessive moisture adheres to the exterior of the seeds, thereby creating a shiny appearance for the According to one embodiment, the excessive moisture is “flashed off.” That is, the first drying system applies a high temperature to the seeds, and when the hot steamed seed makes contact with the ambient air, the excessive moisture evaporates quickly or “flashes off.”

After the excessive moisture is removed, the seed, according to one embodiment, is conveyed to a separation apparatus. The separation apparatus is an apparatus that operates to remove any foreign objects from the seed, including any objects that are either larger or smaller than the seed. According to one embodiment, the separation apparatus is any device that can be used for separating, sifting, or classifying objects by physical size. In one aspect of the invention, the separation apparatus is a lump sifter. In an alternative embodiment, the method of the present invention also includes removing any particles that are smaller than the seeds (also referred to as “fines”). Fines can restrict airflow and reduce drying efficiencies. In one embodiment, the fines must be removed before the seed is placed in the second drying system.

According to one embodiment, the seed is then conveyed to a second drying system. According to one embodiment, the second drying system can also be referred to as the “main dryer.” The seed is thereby dried to a level of about eight to nine percent moisture.

The seed, in one aspect of the present invention, is then processed into powder form. In one aspect of the invention, the seed is conveyed to another location for processing the seed into powder. One method of conveyance can be pressure pneumatics. According to one embodiment, the seed is processed into powder using a grinding process. The grinding process can be accomplished using a pin mill, a hammer mill, a roller mill, a ball mill, or any other known apparatus for processing mustard seed into powder form. Such mills are sold at Buhler, Inc., Hosokawa-Bepex in Minneapolis, Minn., or Kice Industries, Inc. in Wichita, Kans.

In one alternative embodiment, the mustard powder is then conveyed through a metal removal apparatus. The apparatus operates to remove any metal object present in the powder prior to further processing. In one aspect of the present invention, the apparatus transmits a radio frequency which the product flows through. When a metal object passes through the radio frequency being applied to the product, the frequency changes. The change in frequency triggers the apparatus to divert the product flow, thereby discharging the metal object. Alternatively, the apparatus can be any known device for separating or removing metal from any grain or food product.

The powder, according to one aspect of the present invention, is then packaged. According to one embodiment, the powder is packaged by placing the powder in a bag. In one embodiment, the bag has a capacity of 20 lbs. Alternatively, the bag has a capacity of 50 lbs., 1,000 lbs., or 2,000 lbs. In a further alternative, the bag can have any known capacity.

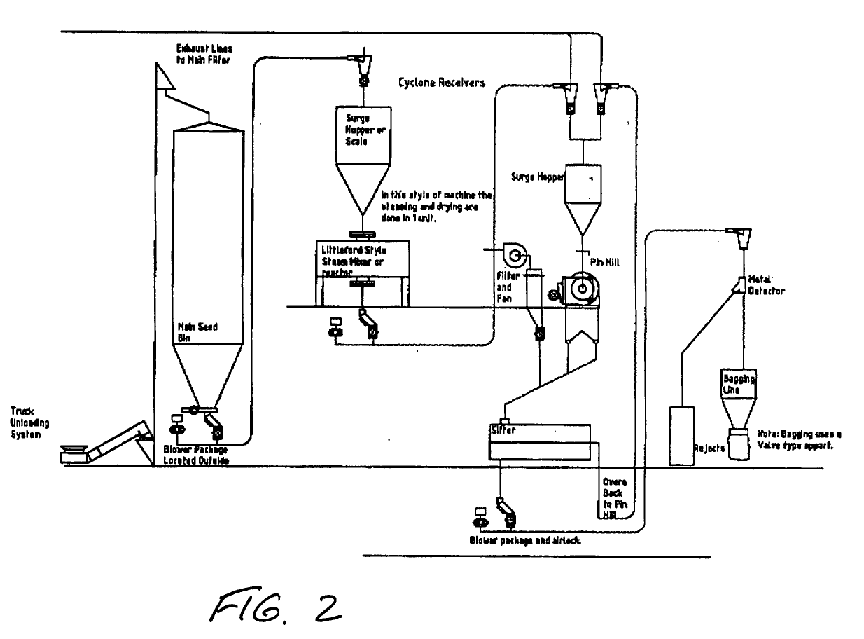

In an alternative aspect of the present invention, the deheating process can be performed using any known deheating technology. FIG. 2 depicts one system utilizing deheating technology. One known apparatus for use in the deheating process of the present invention involves the use of a Littleford reactor or steam mixer. Most of the reactors that can be purchased from Littleford Day Inc. in Florence, Ky. will work with the present invention and provide similar results. A similar device can be purchased from Buhler Inc. The system can include a series of hoppers above and below the steam unit. The first hopper can be filled with a predetermined amount of seed, which is then dumped into the steam mixer. The mixer is sealed, activated, and steam is applied to the seed. When the minimum levels as set forth above for temperature and moisture have been achieved for the minimum amount of time, the steam application ceases and a vacuum pump operates to begin the drying and cooling process for the seed. The drying system can be operated until the seed reaches the specific moisture required for further processing.

A further known pressurization device that may be used with the present invention is a pressure pasteurization device typically used for processing of spices. The pressurization device can be purchased from Stork N.V., a company located in Naarden, the Netherlands. The device is similar to the known pressurized steam chamber above except that the pressure pasteurization device differs with respect to its inlet and outlet components. The design is based on the premise of gentle sterilization. In addition, the drying component is a fluidized bed dryer that can provide an effect and gentle means of cooling and drying.

An additional known pressurization device that may be used with the present invention is a steam reactor. One such device is a batch cooking machine designated as Model BSTC, sold by Buhler, Inc. The reactor chamber can hold about 190 pounds of product. The chamber subjects the seed to a high pressure steam that is at 235 degrees C. for a time period of 25 seconds and at a pressure of 4.5 bar (almost 70 psi). This system is used in the chocolate industry for sterilization of cocoa.

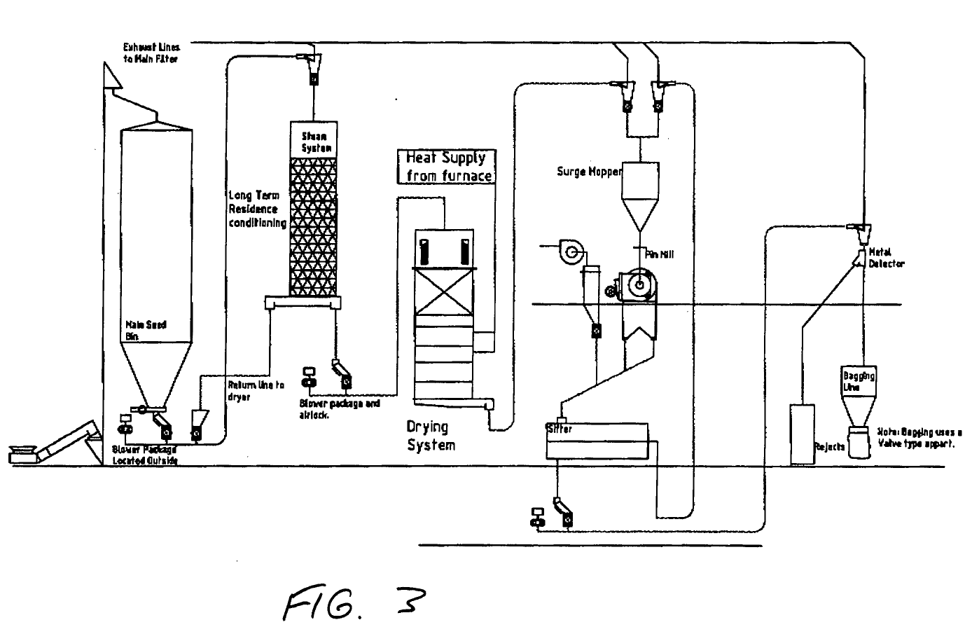

A further known vertical conditioning system that may be used with the present invention is a system with no moving internal parts, also referred to as a “kiln.” FIG. 3 depicts one such system. These devices are sold by Buhler, Inc. and Codema. This system is typically used with grains such as oats. The system operates by applying heat and moisture to the seed and circulating the seed around and back up to the top of the unit until the product is brought up to the appropriate temperature. The seed can then be conveyed to a temporary storage silo.

Yet another known device that may be used with the present invention is a preheating system developed at North Dakota State University. The preheating system has a dry heat source that pushes or pulls forced air through the mustard seed. The system can also have a heat transfer point that is a modified screw conveyor or some type of grain dryer that can preheat the seed to at least 150 degrees Fahrenheit before the seed enters the main steam chamber. The seed chamber is steam-jacketed and the seed is spread in the chamber so that the thin layer of product makes contact with either the steam or the steam-jacketed housing. After the conditioning, the seed is dried using known commercial equipment.

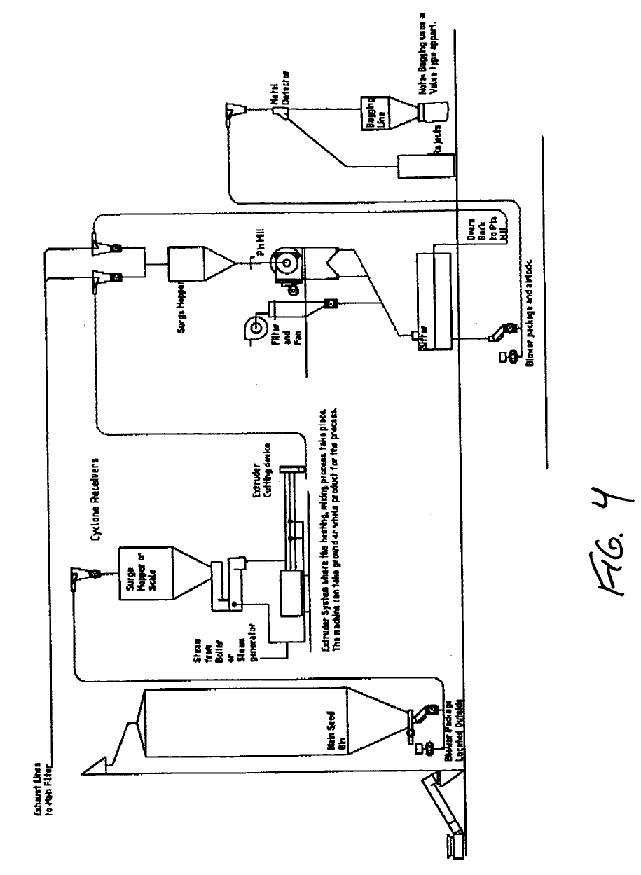

Yet another known device that may be used with the present invention is a twin screw extruder. FIG. 4 depicts system utilizing a twin screw extruder. Versions of this device can be purchased from Buhler, Inc. or Clextral, Inc., located in Tampa, Fla. The extruder can operate in the following manner. The mustard seed is ground and then processed through the extruder, in which the powder is placed under high temperature, moisture, high shear, and pressure. Upon exiting the extruder, the product typically is cut into smaller pieces, dried, and cooled, and then re-ground into a powder again. Alternatively, the mustard seed can be processed through the extruder in whole seed form and subsequently ground into powder form.

A known process that may be used with the present invention is a de-fatting process used in oil extraction. The process includes crushing the seed or placing the seed through a hexane extraction system to remove the oils from the seed. The final product is a cake-like defatted material.

In a further embodiment, the present invention relates to a method of using mustard or processed mustard as an insect or rodent repellent or preservative.

According to one embodiment, unprocessed mustard or the processed mustard resulting from the above-described deheating process can be used as an insect repellent. In one embodiment, the mustard powder (either unprocessed or deheated) is applied to the floor in the target area. The powder is allowed to remain on the floor for a minimum of about 5 minutes after application. Alternatively, the powder is allowed to remain on the floor for a minimum of about 10 minutes. In a further alternative, the powder is allowed to remain on the floor for a minimum of about 30 minutes. In yet another alternative, the powder is allowed to remain on the floor for any amount of time from about 1 minute to 1 week. In accordance with a further alternative, the powder is allowed to remain on the floor indefinitely.

According to one aspect of the present invention, the mustard powder (unprocessed or processed) can be applied to concrete floors that have been smoothed to an even finish. Alternatively, it can be applied to floors that have been epoxy coated. In a further alternative, the mustard powder can be applied to any known type of floor. In yet another alternative, the mustard powder can be applied to a target area on any known surface, such as walls, roofs, etc.

After the powder has remained on the floor for the chosen period, the powder is removed. According to one embodiment, the powder is removed using a broom having fine bristles. Alternatively, the powder is removed using any known broom or brush. In a further alternative, the powder is removed using a dust mop. In yet a further alternative, the powder can be removed using any known “cleaning apparatus,” which term shall be used herein to mean any known apparatus for dusting, mopping, cleaning, wiping, or brushing dust or debris from a surface without the use of water.

Because of the slight oil content of the mustard powder, the use of a cleaning apparatus results in a small amount of the powder remaining as residue on the floor. According to one embodiment, the residue is a micro residue. Alternatively, the powder is removed by any known method or apparatus that allows some residue of the powder to remain on the floor.

According to one embodiment, the amount of mustard powder applied to a floor can range from about 5 pounds to about 1,000 pounds per 1000 ft² of floor space. Alternatively, the amount of powder applied to a floor can range from about 20 pounds to about 50 pounds per 1000 ft² of floor space. In a further alternative, the amount of mustard powder applied to a floor is about 30 pounds per 1000 ft² of floor space.

According to one embodiment, the mustard powder, either unprocessed or deheated, of the present invention can be applied about once a week. Alternatively, the powder can be applied with a frequency ranging from about once a day to about once a year. In a further alternative, the powder can be applied with any frequency appropriate or necessary to control or repel insects at the target location.

In an alternative embodiment, unprocessed mustard can be used as rodent repellent. According to one embodiment, the unprocessed mustard utilized in this embodiment is known ground mustard used in the meat industry. Application of the mustard powder on the floors or in the corners of a building can repel rodents, causing them to vacate the area or building.

In one embodiment, the unprocessed mustard powder is applied to the floor or ground such that any rodent must come into contact with the powder to enter a target area. The powder is applied in an amount such that the powder is visible to the human eye and such that some of the powder adheres to a rodent that comes into contact with the powder.

In one aspect of the invention, the powder is applied in a barrier-like configuration. That is, the powder is applied around the target area such that any rodent must cross a barrier of the powder. The “barrier” is an area in which the powder has been placed such that when a rodent enters the barrier, an effective amount of powder will adhere to the rodent. Into contact with the powder or “cross the barrier” to get to that target area. The barrier, for example, can be a line of powder encircling the target area. The barrier, according to one embodiment, is a foot thick. Alternatively, the barrier is six inches thick. In a further alternative, the barrier is any thickness that ensures that some powder adheres to any rodent crossing the barrier. In one example, to repel rodents from a target area that is a storage area in a warehouse, a barrier of powder that is twelve inches thick is placed such that it encircles the storage area.

According to one aspect of the present invention, the unprocessed mustard powder can be applied to concrete floors. Alternatively, the mustard powder can be applied to any known type of floor. In yet another alternative, the mustard powder can be applied to a target area on any known surface, such as walls, roofs, the ground, etc.

According to one embodiment, the mustard powder, either unprocessed or deheated, of the present invention can be applied about once a month. Alternatively, the powder can be applied with a frequency ranging from about once a week to about once a year. In a further alternative, the powder can be applied with any frequency appropriate or necessary to control or repel rodents at the target location.

Without being limited by theory, it is believed that the application of the powder operates to repel rodents in the following manner. Mustard contains myrosinase—an enzyme that, when combined with moisture, is known to cause a burning sensation when placed in contact with an animal's skin or fur. It is believed that the mustard powder placed in appropriate locations will stick to portions of a rodent that comes into contact with the powder. It is further believed that moisture is typically present on mice and rats as a result of two separate phenomenon. First, mice and rats do not have bladders and thus are constantly urinating. Thus, portions of the rodent are moist as a result of this urination. Second, rodents lick their fur and feet as a method of cleansing themselves, thereby moistening those portions of their bodies. Thus, as a rodent comes into contact with the mustard powder, the powder attaches or sticks to the moist portions of the rodent's body and causes a burning sensation. Further, it is believed that a rodent is likely to react to this burning sensation by licking the area of discomfort, thereby causing the burning sensation to occur in and around the rodent's mouth as well, while also adding more moisture to the original area of the burning sensation, thereby further strengthening the burning sensation in that area.

Thus, the uncomfortable burning sensation caused by the mustard powder would cause the rodent to avoid and/or leave those areas in which the powder has been placed, thereby providing an effective method for repelling rodents from specific areas.

In accordance with a further embodiment of the present invention, the deheated mustard powder is used as a coating for whole grain or cut grain products that has insect repellent and preservative properties. The powder is applied to the grain using a drum coating system. According to one embodiment, the drum coating system is any known drum coating system such as the systems used to coat snacks or cereal products with sugar or sweeteners. Alternatively, the powder is applied to the grain by any known dry application technique.

The coating of mustard powder acts as an insect repellent and preservative for the grain product, thereby increasing the shelf life of the grain product. The coating not only acts as an insect repellent as described above but also as a preservative as a result of the known antioxidant properties of deheated mustard powder.

In an alternative embodiment, the deheated mustard powder of the present invention can be mixed with water to create a deheated mustard liquid that can be used as a spray. In one embodiment, the spray can be created using a mixing apparatus. The spray can be applied to whole grain or cut grain products to create a coating that serves as an insect repellent and a preservative as described above. In accordance with one aspect of the invention, the deheated mustard spray is applied using a spray application apparatus and can be stored in any known liquid storage container.

In accordance with a further alternative, one or more additives may be added to the mustard. The addition of an additive or additives can enhance the insect repellent or preservative effects of the mustard or can provide for additional uses for the composition.

In one example, the additive is an inert material. According to one embodiment, the inert material improves the flow characteristics of the mustard to allow for better flowability. The inert material can also serve as a filler to allow for better distribution of the mustard on the target surface. According to one embodiment, the inert material is ground rice hulls, barley bran, ground barley hulls, ground buckwheat hulls, or bran. In a further alternative, the additive can be any known material that may enhance the effects of the mustard or provide for additional uses for the composition.

### EXAMPLE

Deheated mustard powder according to the present invention was applied to a milling and flaking facility owned by Minnesota Grain in an amount of 30 pounds per 1000 ft² of floor space on a weekly basis. Within about one week of the beginning of the application, personnel in the plant observed a substantial decrease in insect activity in the areas of the plant to which the powder was being applied. Further, during the summer months when insect activity is typically at its highest levels, no insect tracks were observed in the plant. In addition, an auditor from RQA Quality Assurance (an official NFPA auditing firm) inspected the plant and stated that “there is no insect activity at all at Minnesota Grain.”

Although the present invention has been described with reference to preferred embodiments, persons skilled in the art will recognize that changes may be made in form and detail without departing from the spirit and scope of the invention.

What is claimed is:

1. A method of reducing the presence of insects in a target area, the method comprising:
applying mustard powder to the target area; and
removing a portion of the mustard powder from the target area.

2. The method of claim 1, wherein the mustard powder comprises unprocessed mustard.

3. The method of claim 1, wherein the mustard powder comprises deheated mustard.

4. The method of claim 1, wherein removing the portion of the mustard powder further comprises removing the portion of the mustard powder with a cleaning apparatus.

5. The method of claim 4, wherein the cleaning apparatus comprises a broom.

6. The method of claim 4, wherein the cleaning apparatus comprises a dust mop.

7. The method of claim 1, wherein removing the portion of the mustard powder further comprises removing the portion of the mustard powder after allowing the mustard powder to remain at the target area for a predetermined amount of time.

8. The method of claim 7, wherein the predetermined amount of time ranges from about 1 minute to about 1 week.

9. The method of claim 1, wherein applying mustard powder to the target area further comprises applying the mustard powder to the target area in an amount ranging from about 5 pounds to about 1,000 pounds per 1,000 ft² of the target area.

10. A method of reducing the presence of rodents in a target area, the method comprising:
applying a barrier of mustard powder around the target area.

11. The method of claim 10, wherein the mustard powder comprises unprocessed mustard.

12. The method of claim 10, wherein applying mustard powder to the target area further comprises applying the mustard powder monthly.

13. The method of claim 10, wherein the barrier is configured such that a portion of the mustard powder adheres to a rodent when the rodent contacts the powder.

14. A method of coating a grain product, the method comprising:
spraying a mixture onto a grain product to create a coating on the grain product, the mixture comprising deheated mustard powder and water,
wherein the coating comprises insect repellent and preservative characteristics.
